(19) United States
(12) Patent Application Publication
(10) Pub. No.: US 2010/0129125 A1
(43) Pub. Date: May 27, 2010

(54) LIGHT-ABSORPTIVE DEVICE, FIXING UNIT USING THE LIGHT-ABSORPTIVE DEVICE, AND IMAGE FORMING APPARATUS

(75) Inventors: Seung-Jin Oh, Seoul (KR); Dae-Hwan Kim, Seoul (KR); Sun-Rock Choi, Hwaseong-si (KR); Joo-Ho Kim, Suwon-si (KR); Woo-Kyu Kim, Suwon-si (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/625,150

(22) Filed: Nov. 24, 2009

(30) Foreign Application Priority Data
Nov. 27, 2008 (KR) 10-2008-0118812

(51) Int. Cl. G03G 15/20; G02B 5/22

(52) U.S. Cl. 399/333; 359/885

(57) ABSTRACT

A light-absorptive device for absorbing light includes a light source configured to emit light and a light-absorptive element configured to absorb the light emitted from the source. The light-absorptive element includes a light-absorptive layer in which a nano-component comprised of one or more nano particles coated with a shape keeping agent is dispersed. The aspect ratio(s) and/or the dielectric constant of the light-absorptive layer may be selectively varied to realize a peak wavelength of absorption spectrum that corresponds to the wavelength(s) of the light emitted by the light source. The light-absorptive device may be incorporated as a heating unit, such as a fixing unit of an image forming apparatus to fix toner images on to a recording medium.

### CROSS-REFERENCE TO RELATED PATENT APPLICATIONS

This application claims the benefit of Korean Patent Application No. 10-2008-0118812, filed on Nov. 27, 2008, in the Korean Intellectual Property Office, the disclosure of which in its entirety is incorporated herein by reference.

### TECHNICAL FIELD

The present disclosure relates generally to a light-absorptive device having an improved thermal efficiency, a fixing unit using the light-absorptive device, and an image forming apparatus incorporating such fixing unit.

### BACKGROUND OF RELATED ART

Light-absorptive devices for absorbing light emitted from a light source may be used as a heating device utilizing the absorbed light energy as the source of heat. A light-absorptive device may be used for, for example, a fixing unit in an electrophotographic image forming apparatus.

In an electrophotographic image forming apparatus, after a photosensitive drum is uniformly charged, the photosensitive drum is exposed to light using a laser scanning unit (LSU) to form an electrostatic latent image according to an image signal. Toner that is charged by a developing unit is supplied to the photosensitive drum to form a toner image. The toner image is transferred to a recording medium. The toner image transferred to the recording medium is not fixed at this point, but is merely carried on the recording medium. By heating and pressing the toner image using a fixing unit, the toner image is thermally used or otherwise fixed on the recording medium so that a fixed image may be formed on the recording medium. For example, in a roller type fixing unit, as the recording medium holding the toner image passes through a nip portion that is formed between a heating roller and a press roller which are in a pressing contact with each other, the toner image on the recording medium is heated by the heat from the heating roller and simultaneously pressed by the heating roller and the press roller, thereby being fixed on the recording medium. The heating roller may generally have the form of a metal roller having a cylindrical shape and may be heated by a heat source, such as, for example, a halogen lamp, and is an example of a light-absorptive device.

### SUMMARY OF THE DISCLOSURE

According to an embodiment, a light-absorptive device with an improved thermal efficiency configured to absorb light emitted from a light source may include a light-absorptive element having a light-absorptive layer in which a nano-component, obtained by coating a nano particle with a shape keeping agent, is dispersed.

According to another embodiment, a fixing unit may include a light source, a heating member configured to absorb light emitted from the light source and including a light-absorptive layer in which a nano-component obtained by coating a nano particle with a shape keeping agent is dispersed, and a press member configured to form a fixing nip by facing and pressing against the heating member.

The shape keeping agent may be, for example, silica or carbon.

The nano particle may be, for example, a nano-sphere or a nano-rod. The nano particle may be formed of at least one metal selected from the group including Ag, Au, Pt, Pd, Fe, Ni, Al, Sb, W, Tb, Dy, Gd, Eu, Nd, Pr, Sr, Mg, Cu, Zn, Co, Mn, Cr, V, Mo, Zr and Ba.

A medium of the light-absorptive layer may be polymer. The polymer may be a fluorine based resin such as PFA (Perfluoroalkoxy) or PTFE (Polytetrafluoroethylene), for example.

The light source may be configured to emit light of a single wavelength, and the nano particle may have an aspect ratio at which a peak wavelength of absorption spectrum of the nano particle is a wavelength of the light emitted from the light source.

The light source may be configured to emit light of multiple wavelengths, and the nano particle may have a plurality of aspect ratios, the plurality of aspect ratios of the nano particle being set to allow a peak wavelength of absorption spectrum of the nano particle to belong to a wavelength of the light emitted from the light source.

The light-absorptive layer may include a plurality of dielectric layers having different dielectric constants. The dielectric constant of each of the plurality of dielectric layers may be set to allow a peak wavelength of absorption spectrum of the nano particle to belong to a wavelength of the light emitted from the light source.

According to another embodiment, an image forming apparatus may include a printing unit configured to transfer a toner image to a recording medium using an electrophotographic method; a fixing unit which includes a light source; a heating member configured to absorb light emitted from the light source and including a light-absorptive layer in which a nano-component obtained by coating a nano particle with a shape keeping agent is dispersed; and a press member forming a fixing nip by facing and pressing against the heating member.

### BRIEF DESCRIPTION OF THE DRAWINGS

Various features and advantages of the disclosure will become more apparent by the following detailed description of several embodiments thereof with reference to the attached drawings, of which:

FIG. 1 schematically illustrates the structure of a light-absorptive device according to an embodiment;

FIG. 2 illustrates an example of a nano-composite;

FIG. 3 is a graph qualitatively showing that a wavelength for maximizing a light energy absorption rate varies as the aspect ratio of nano-rod changes;

FIG. 4 schematically illustrates the structure of a light-absorptive device according to another embodiment;

FIG. 5 schematically illustrates the structure of a light-absorptive device according to yet another embodiment;

FIG. 6 is a graph showing that a wavelength for maximizing a light energy absorption rate of a nano-composite varies as the dielectric constant of a dielectric layer in which the nano-composite is dispersed changes;

FIG. 7 schematically illustrates the structure of a fixing unit according to an embodiment; and

FIG. 8 schematically illustrates the structure of an image forming apparatus according to an embodiment.

### DETAILED DESCRIPTION OF SEVERAL EMBODIMENTS

Reference will now be made in detail to the embodiment, examples of which are illustrated in the accompanying drawings, wherein like reference numerals refer to like elements throughout. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

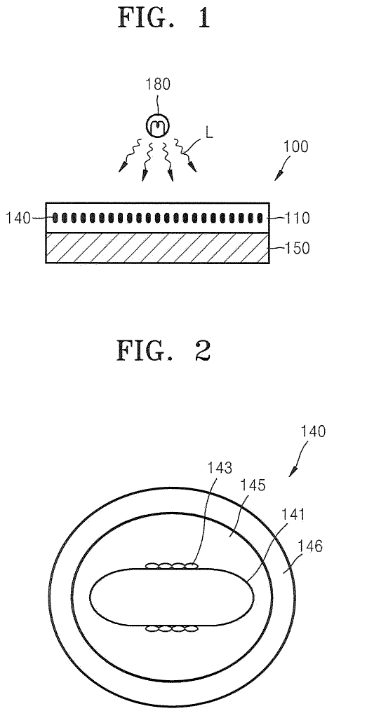

FIG. 1 schematically illustrates the structure of a light-absorptive device according to an embodiment. Referring to FIG. 1, the light-absorptive device may include a light-absorptive element 100 and a light source 180. The light source 180 may be configured to emit light L to a light-absorptive layer 110 of the light-absorptive element 100. A halogen lamp or a semiconductor laser diode, for example, may be employed as the light source 180. Other types of light sources may alternatively or additionally be employed as the light source 180. A reflection member (not shown) for guiding light to the light-absorptive element 100 may be further provided around the light source 180. Although the present embodiment the light-absorptive device is described as including the light source 180, an external light source, such as sun light, may be used as the light source 180 so that the light source 180 need not be separately provided.

The light-absorptive element 100 is configured to absorb the light L emitted from the light source 180, and may include the light-absorptive layer 110, in which a nano-composite 140 is dispersed, and a substrate 150 configured to support the light-absorptive layer 110. The substrate 150 may be a layer coated with the light-absorptive layer 110. The substrate 150 may be heated, and may be a heat transfer medium that transfers heat.

The light-absorptive layer 110 is a layer configured to absorb energy of the incident light L, and to convert the absorbed energy to thermal energy. When the light-absorptive device according to an embodiment is applied to a heating member of a fixing unit, fluorine based resin, such as perfluoroalkoxy (PFA) or polytetrafluoroethylene (PTFE), for example, may be used as the medium of the light-absorptive layer 110.

The nano-composite 140 may comprise a plurality of nano particles on which a shape keeping agent is coated thereon to improve thermal stability of the nano particles. Each nano particle may be, for example, a nano-rod or a nano-sphere having a size of several nanometers through hundreds of nanometers.

A surface plasmon resonance phenomenon may be generated at a boundary surface between a typical dielectric material having a positive dielectric characteristic and a material having a negative dielectric characteristic when the typical dielectric material having a positive dielectric characteristic and the material having a negative dielectric characteristic contact each other. In particular, the surface plasmon resonance phenomenon may be easily generated in metal having a high negative dielectric characteristic. The nano particle used for the nano-composite 140, according to an embodiment, may be formed of metal having the surface plasmon resonance phenomenon. For example, a nano-rod formed of metal selected from a group of Ag, Au, Pt, Pd, Fe, Ni, Al, Sb, W, Tb, Dy, Gd, Eu, Nd, Pr, Sr, Mg, Cu, Zn, Co, Mn, Cr, V, Mo, Zr, and Ba may be used as the nano particle. When the surface plasmon resonance phenomenon is generated in the nano particle, the reflection or dispersion of light incident on the nano particle may be restricted and the light energy absorption rate of the nano particle may accordingly be at or near a peak. Accordingly, photo-thermal energy conversion may efficiently be achieved.

With reference to FIG. 2, the nano-composite 140, according to an embodiment, is illustrated. Silica or carbon, for example, may be used as the shape keeping agent that is applied to or coated on the nano particle. Referring to FIG. 2, the nano-composite 140 may have, according to an embodiment, a structure in which silica (SiO₂) 146 is coated on a gold (Au) nano particle 141 having a modified surface. A surfactant 143, such as hexadecyltrimethylammonium bromide (C16TAB), may encompass the gold (Au) nano particle 141, for example. A silane coupling agent 145 may be for example, HSRSi(OR)₃.

To manufacture the nano-composite 140, first, the surface of the gold (Au) nano particle 141 may be modified using HSRSi(OR)₃, such as 3-Mercaptopropyl trimethoxysilane (MPTS, HS(CH₂)₃Si(OCH₃)₃), as the silane coupling agent. “R” may be CH₃. Accordingly, the surface modification of the gold (Au) nano particle 141 may allow the gold (Au) nano particle 141 to maintain a stably dispersed state in another solvent as well as in water. Sodium silicate resin may be mixed on the surface-modified gold (Au), and may be magnetically stirred. After several days, a nano-composite in which a gold (Au) nano particle is inserted in a silica shell may be formed.

The above method of manufacturing a nano-composite is merely an example, and a variety of other methods known in the field may be employed. For example, a nano-composite may be manufactured by growing silica on anodized aluminum oxide (AAO) having a porous structure to form a thin layer, making a silica-coated AAO pore, and growing a metal particle in the silica-coated AAO pore. As an another example, an amorphous carbon shell may be formed on a nano-rod using a resistive heating evaporation method. In addition, to stabilize and improve the mechanical characteristic of the nano-composite, a variety of nano-composites in which the nano particle is surrounded by a rigid matrix, such as polymer, glass, or ceramic, (i.e., the shape keeping agent) may be used.

The light-absorptive device may absorb the light L emitted from the light source 180, as shown in FIG. 1, and may covert the absorbed light to thermal energy to heat the light-absorptive device itself and/or a subject to be heated. A fixing unit of an image forming apparatus, for example, may maintain a temperature of about 180° C. A pure nano particle may be thermally deformed at such high temperature so that the shape of the nano particle may not be stably maintained. The thermal deformation may change the aspect ratio of the nano particle, thereby changing the peak wavelength of an absorption spectrum. In an embodiment, by using a nano-composite in which a shape keeping agent is coated on a nano particle, the thermal deformation of a nano particle at high temperature may be mitigated so that thermal stability may be improved.

The wavelength of light generating the surface plasmon resonance phenomenon may vary according to the aspect ratio of the nano particle 141 in the nano-composite. By varying the aspect ratio of the nano particle 141, the wavelength that maximizes the light energy absorption rate of the nano-composite 140 may be changed.

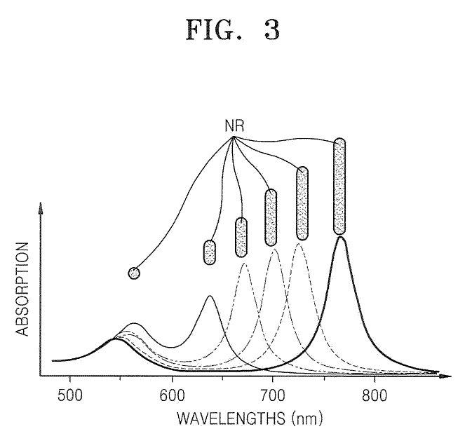

FIG. 3 is a graph qualitatively showing that a wavelength corresponding to the peak of a light energy absorption rate varies by changing the length of a nano-rod (NR) having the same diameter. Referring to FIG. 3, it is illustrated that a wavelength corresponding to the peak of a light energy absorption rate gradually increases as the aspect ratio of the nano-rod (NR) increases. The wavelength of light generating the surface plasmon resonance phenomenon and the aspect ratio of the nano-rod (NR) may vary according to the specific material of metal forming the nano-rod (NR).

Referring again to FIG. 1, when the light source 180 emits the light L in a predetermined wavelength range, such as, for example, with a semiconductor laser diode, a nano-rod having an aspect ratio at which the peak wavelength of the absorption spectrum of the nano-rod matches the wavelength of the light L emitted from the light source 180 may be used.

When a multi-wavelength light source, such as a halogen lamp, is used as the light source 180, the nano-rod may have a variety of aspect ratios. In such an embodiment, the aspect ratio of the nano-rod may be set such that the peak wavelength of the absorption spectrum belongs to the wavelength range of the light L emitted from the light source 180.

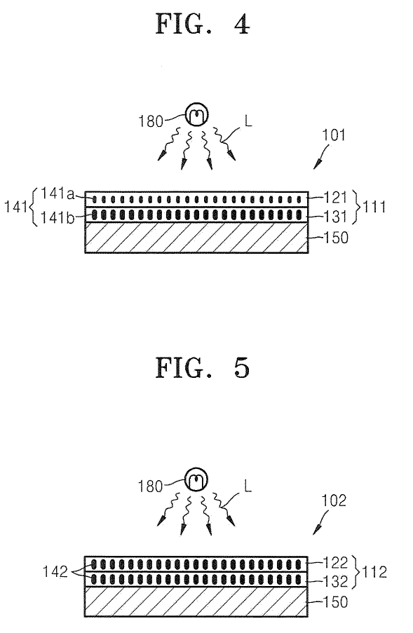

FIG. 4 schematically illustrates the structure of a light-absorptive device according to another embodiment. Referring to FIG. 4, a light-absorptive device may include a light-absorptive element 101 and a light source 180. A multi-wavelength light source, such as a halogen lamp, may used as the light source 180. The light-absorptive element 101 has a structure that includes a multilayered light-absorptive layer 111 provided and positioned on a substrate 150. A plurality of nano-composites 141, which may comprise a plurality of nano particles having different aspect ratios with a shape keeping agent coated thereon, are dispersed in the multilayered light-absorptive layer 111.

If the light source 180 emits light of multiple wavelengths, the aspect ratio of the nano particle may have different values at which the peak wavelength of the absorption spectrum belongs to the multiple wavelength range of the light L emitted from the light source 180. Accordingly, the light-absorptive layer 111 may include first and second layers 121 and 131, in which first and second nano-composites 141a and 141b are respectively dispersed. The first and second nano-composites 141a and 141b each are obtained by coating the shape keeping agent on the nano particles having different aspect ratios at which the peak wavelength of the absorption spectrum belongs to the multiple wavelength range of the light L emitted from the light source 180. Additionally, the nano particles of the light-absorptive layer 111 may have aspect ratios of three or more different values. Moreover, the light-absorptive layer 111 is not limited to a double layer structure and may be a three or more layer structure.

FIG. 5 schematically illustrates the structure of a light-absorptive device according to another embodiment. Referring to FIG. 5, a light-absorptive device may includes a light-absorptive element 102 and a light source 180. A multi-wavelength light source, such as a halogen lamp, may be used as the light source 180. The light-absorptive element 102 may include a multilayered light-absorptive layer 112 provided and positioned on the substrate 150. The light-absorptive layer 112 may include first and second dielectric layers 122 and 132 in which a plurality of nano-composites 142 are dispersed.

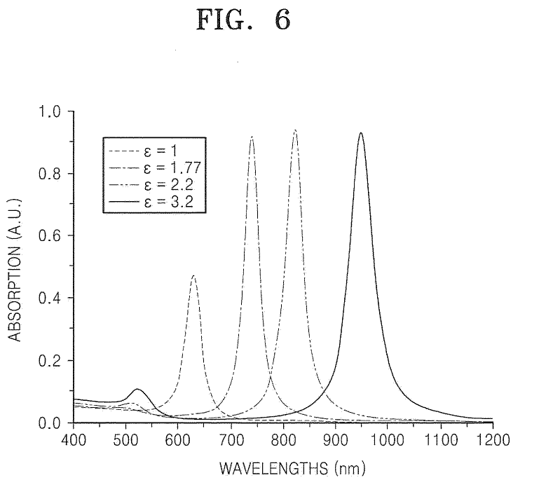

With reference to FIG. 6, which illustrates that the wavelength maximizing the light energy absorption rate of a nano-composite varies as the dielectric constant of the dielectric layer in which the nano-composite is dispersed changes. A surface plasmon resonance condition generated in the nano-composite 142 may vary according to the dielectric constant of a medium around the nano-composite 142. Thus, the wavelength of light generating the surface plasmon resonance can be changed by the dielectric constant of the medium around the nano-composite 142.

Referring back to FIG. 5, the first and second dielectric layers 122 and 132 forming the light-absorptive layer 112 may have different dielectric constants. If the light source 180 is a halogen lamp, for example, the wavelength range of light that is emitted may be of a relatively wide range. To allow the peak wavelength of the absorption spectrum of the nano-composite 142 to belong to the wavelength range of the light emitted from the halogen lamp, the dielectric constants of the first and second dielectric layers 122 and 132, in which the nano-composite 142 is dispersed, may be accordingly adapted so that the light energy absorption rate may be effectively increased.

The light-absorptive layer 112 is not limited to the two dielectric layers 122 and 132 and may be formed of three or more dielectric layers. If the light-absorptive layer 112 is formed of three or more dielectric layers, the light absorption rate may be increased by adjusting the dielectric constant of each dielectric layer such that the peak wavelength of the absorbed light energy is located in the wavelength spectrum of the light source 180.

In an embodiment where the wavelength at which the light energy absorption rate becomes maximum is adjusted by changing the dielectric constants of the first and second dielectric layers 122 and 132, the aspect ratio of the nano particle of the nano-composite 142 dispersed in the first dielectric layer 122 and the aspect ratio of the nano particle of the nano-composite 142 dispersed in the second dielectric layer 132 may be the same or substantially the same (i.e. within a margin of error in a manufacturing process; nano particles manufactured under the same process condition may have substantially the same aspect ratio).

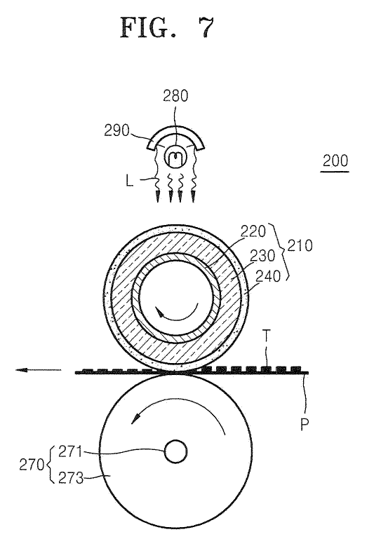

FIG. 7 schematically illustrates the structure of a fixing unit 200 according to an embodiment. Referring to FIG. 7, the fixing unit 200 may include a heating roller 210, a press roller 270 and a light source 280.

The heating roller 210 may have a cylindrical shape and may be capable of rotating axially. The heating roller 210 may include an inner pipe 220, an elastic layer 230 and a light-absorptive layer 240.

The inner pipe 220 may be configured to support and/or sustain the shape of the heating roller 210, and may also function as a rotation shaft. The inner pipe 220 may comprise a core pipe formed of, for example, metal, such as iron, steel, stainless steel, aluminum, or copper; an alloy; ceramics; or a fiber reinforced metal (FRM). Other structures may be utilized in place of the inner pipe 220, such as, for example, a shaft having a rod shape.

The elastic layer 230 of the heating roller 210 is, according to an embodiment, provided on the outer circumferential surface of the inner pipe 220. The elastic layer 230 may be formed of silicon rubber or fluorine rubber, for example. The silicon rubber may be RTV silicon rubber or HTV silicon rubber. Poly dimethyl silicon rubber, metal vinyl silicon rubber, methal phenyl silicon rubber, or fluorine silicon rubber may alternatively or additionally be used.

The light-absorptive layer 240 of the heating roller 210 may comprise a layer in which a nano-composite is dispersed, in which a photo-thermal energy conversion is performed by the surface plasmon resonance phenomenon of the nano particles in the nano-composite.

The medium of the light-absorptive layer 240, in which the nano-composite is dispersed, may be formed of polymer that exhibits, a thermal stability. A releasable resin, such as fluorine based rubber, silicon based rubber, or fluorine based resin, may be used as the medium of the light-absorptive layer 240. For example, fluorine based resin such as PFA or PTFE may be used as the medium of the light-absorptive layer 240. The releasable resin may function to separate a recording medium P from the heating roller 210 in a fixing process, for example. According to an embodiment, a release layer formed of a releasable resin may be separately provided on the outer circumferential surface of the light-absorptive layer 240. The fixing unit 200 is not limited to the heating roller 210. For example, a belt having a heat-absorptive layer may be utilized as the heating member of the fixing unit 200.

In an embodiment, if nano-composite exhibiting thermal stability is dispersed in the light-absorptive layer 240, the light-absorptive layer 240 may be stably formed on the heating roller 210. For example, in a conventional process of forming a release layer formed of PFA on the heating roller, a FPA film is inserted in a roller and is thermally contracted through a plastic process at 400° C. In the above-described embodiment, the heating roller 210 may be manufactured without a drastic change in the conventional manufacturing method due to the use of thermally stable nano-composite.

The press roller 270 of the fixing unit 200 may have a cylindrical shape and may be capable of rotating axially. The press roller 270 may have a structure in which a heat-resistant elastic layer 273 is wound around a metal core member 271. The heat-resistant elastic layer 273 may be formed of for example, silicon rubber.

With reference to FIG. 7, according to an embodiment, a fixing nip portion may be formed between the press roller 270 and the heating roller 210. The heat provided by the heating roller 210 as well as the pressure between the press roller 270 and the heating roller 210 may allow a toner image T, which is formed on a recording medium P that passes through the fixing nip portion, to be fixed on the recording medium P.

The light source 280 may be configured to emit radiation heat, and may include, for example, a halogen lamp, an IR lamp, a light emitting diode, a laser diode, or the like. A reflection member 290 may be configured to guide light emitted from the light source 280 toward the heating roller 210.

The light source 280 may be positioned outside the heating roller 210 to emit radiation heat to the outer circumferential surface of the heating roller 210. Since the radiation heat may be emitted directly to the outer circumferential surface of the heating roller 210 and furthermore since the light-absorptive layer 240 is provided on the outer circumferential surface of the heating roller 210, the temperature of the surface of the heating roller 210 may be quickly raised. Accordingly, as the surface temperature of the heating roller 210 can be raised to a fixing temperature of for example, 180° C.-200° C. in a short amount of time, first page out time (FPOT) for outputting the first printing medium may be reduced in a printing process, thereby improving the printing speed.

When a halogen lamp is used as the light source 180, the range of the wavelengths of the emitted light may be relatively wide. Accordingly, in order to allow the peak wavelength of the absorption spectrum of nano-composite to belong to the wavelength range of the light emitted from the halogen lamp, as described above, the light energy absorption rate of the light-absorptive layer 240 may be effectively improved by either appropriately selecting the aspect ratios of nano particles in the nano-composite, or by changing the dielectric constants of a plurality of dielectric layers in which the nano-composite is dispersed.

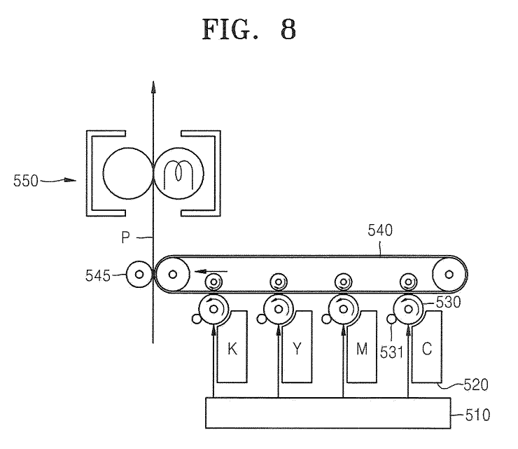

FIG. 8 schematically illustrates the structure of an image forming apparatus according to an embodiment. Referring to FIG. 8, an image forming apparatus may include a light scanning unit 510, a development unit 520, a photosensitive drum 530, a charge roller 531, an intermediate transfer belt 540, a transfer roller 545 and a fixing unit 550. The fixing unit described with reference to FIG. 7 may be used as the fixing unit 550, for example.

The light scanning unit 510 may be configured to scan a light ray modulated according to image information onto the photosensitive drum 530. The photosensitive drum 530 may be a type of photosensitive body, in which a photosensitive layer having a predetermined thickness is formed on the outer circumferential surface of a cylindrical metal pipe. The outer circumferential surface of the photosensitive drum 530 may correspond to a scanned surface, upon which the light ray scanned by the light scanning unit 510 is incident, and upon which electrostatic latent image is thereby formed. In an alternative embodiment, a photosensitive body in the form of belt may be used instead. Toner may be accommodated in the development unit 520. The toner may be moved to the photosensitive drum 530 by a development bias applied between the development unit 520 and the photosensitive drum 530 to develop the electrostatic latent image into a visible toner image.

To print a color image, the light scanning unit 510 may scan four light rays respectively to four photosensitive drums, as illustrated in FIG. 8. As a result, electrostatic latent images corresponding to black K, magenta M, yellow Y, and cyan C image information may respectively be formed on the four photosensitive drums. The four development units may respectively supply toner of the black K, magenta M, yellow Y and can C colors to the photosensitive drum 530, thereby forming a toner image of the black K, magenta M, yellow Y, and cyan C colors.

The charge roller 531 is a charger that may be configured to rotate in contact with the photosensitive drum 530, and may be configured to charge the surface of the photosensitive drum 530 to a uniform electric potential. To that end, a charge bias Vc may be applied to the charge roller 531. According to an alternative embodiment, a corona charger (not shown) may be used instead of the charge roller 531. Other types of charging units may also be utilized.

The toner images of the black K, magenta M, yellow Y, and cyan C colors formed on the four photosensitive drums may be transferred to the intermediate transfer belt 540. The toner images may be transferred to the recording medium P passing between the transfer roller 545 and the intermediate transfer belt 540 by, for example, a transfer bias applied to the transfer roller 545. The toner images transferred to the recording medium P may be fixed on the recording medium P due to the heat and pressure received from the fixing unit 550 so that the formation of an image may be completed.

In the image forming apparatus configured as above, thermal efficiency may be improved if the light-absorptive devices according to the above-described embodiments are used in the fixing unit 550. Furthermore, since the fixing temperature can be quickly raised, the FPOT may be reduced and the printing speed may accordingly be improved.

Moreover, the light-absorptive device according to various described embodiments may be used for various mechanisms that may use or incorporate a radiation heat as a heat source. For example, the light-absorptive device may be used for a heat apparatus using radiation heat. In addition, the light-absorptive device may be used for an apparatus capable of locally heating by intensively emitting light to a marker including a nano-composite. The local heating apparatus may be applied to a variety of fields, such as an apparatus for mounting electronic parts on a printed circuit board and a medical equipment for destroying a tumor by locally applying heat to a marker planted in a tumor in a human body, for example.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims and their equivalents.

What is claimed is:

1. A light-absorptive device for absorbing light, comprising:
a light-absorptive element comprised of a light-absorptive layer in which a nano-component is dispersed, the nano-component comprising one or more nano particles coated with a shape keeping agent.

2. The light-absorptive device of claim 1, wherein the shape keeping agent comprises silica or carbon.

3. The light-absorptive device of claim 1, wherein each of the one or more nano particles comprise a nano-sphere or a nano-rod.

4. The light-absorptive device of claim 3, wherein each of the one or more nano particles comprises at least one metal selected from the group including Ag, Au, Pt, Pd, Fe, Ni, Al, Sb, W, Tb, Dy, Gd, Eu, Nd, Pr, Sr, Mg, Cu, Zn, Co, Mn, Cr, V, Mo, Zr and Ba.

5. The light-absorptive device of claim 1, further comprising a light source configured to emit light to the light-absorptive element.

6. The light-absorptive device of claim 5, wherein the light source is configured to emit light having a single wavelength.

7. The light-absorptive device of claim 6, wherein each of the one or more nano particles having an aspect ratio with which a peak wavelength of absorption spectrum of each of the one or more nano particles corresponds to the single wavelength of the light emitted from the light source.

8. The light-absorptive device of claim 5, wherein the light source is configured to emit light of a range of wavelengths.

9. The light-absorptive device of claim 8, wherein each of the one or more nano particles has a respective corresponding one of a plurality of aspect ratios such that the one or more nano particles have a plurality of peak wavelengths of absorption spectrum, each of which being in the range of wavelengths of the light emitted from the light source.

10. The light-absorptive device of claim 8, wherein the light-absorptive layer comprises a plurality of dielectric layers each having a different dielectric constant from one another, and
wherein ones of the one or more nano particles dispersed in any one of the plurality of dielectric layers having a peak wavelength of absorption spectrum that belongs in the range of wavelengths of the light emitted from the light source.

11. The light-absorptive device of claim 1, wherein the light-absorptive element further comprises a substrate configured to support thereon the light-absorptive layer.

12. A fixing unit, comprising:
a light source configured to emit light;
a heating member configured to absorb light emitted from the light source, the heating member comprising a light-absorptive layer in which a nano-component is dispersed, the nano-component comprising one or more nano particles coated with a shape keeping agent; and
a press member arranged to be in a pressing contact with, and to thereby form a fixing nip with, the heating member.

13. The fixing unit of claim 12, wherein the shape keeping agent comprises silica or carbon.

14. The fixing unit of claim 12, wherein each of the one or more nano particles comprises a nano-sphere or a nano-rod.

15. The fixing unit of claim 12, wherein each of the one or more nano particles comprises at least one metal selected from the group including Ag, Au, Pt, Pd, Fe, Ni, Al, Sb, W, Tb, Dy, Gd, Eu, Nd, Pr, Sr, Mg, Cu, Zn, CO, Mn, Cr, V, Mo, Zr and Ba.

16. The fixing unit of claim 12, wherein the light-absorptive layer comprises a polymer medium.

17. The fixing unit of claim 16, wherein the polymer medium comprises a fluorine based resin.

18. The fixing unit of claim 12, wherein the light source is configured to emit light having a single wavelength.

19. The fixing unit of claim 18, wherein each of the one or more nano particles has an aspect ratio with which a peak wavelength of absorption spectrum of each of the one or more nano particles corresponds to the single wavelength of the light emitted from the light source.

20. The fixing unit of claim 12, wherein the light source is configured to emit light having a range of wavelengths.

21. The fixing unit of claim 20, wherein each of the one or more nano particles has a respective corresponding one of a plurality of aspect ratios such that the one or more nano particles have a plurality of peak wavelengths of absorption spectrum, each of which being in the range of wavelengths of the light emitted from the light source.

22. The fixing unit of claim 20, wherein the light-absorptive layer comprises a plurality of dielectric layers each having a different dielectric constant from one another, and
wherein ones of the one or more nano particles dispersed in any one of the plurality of dielectric layers having a peak wavelength of absorption spectrum that belongs in the range of wavelengths of the light emitted from the light source.

23. The fixing unit of claim 12, wherein the press member comprises a metal core member and a heat-resistant elastic layer wound around the metal core member.

24. An image forming apparatus, comprising:
a printing unit configured to transfer a toner image onto a recording medium; and
a fixing unit comprising:
a light source configured to emit light;
a heating member configured to absorb light emitted from the light source and comprising a light-absorptive layer in which a nano-component is dispersed, the nano-component comprising one or more nano particles coated with a shape keeping agent; and
a press member arranged to be in a pressing contact with, and to thereby form a fixing nip with, the heating member.

25. The image forming apparatus of claim 24, wherein the shape keeping agent comprises silica or carbon.

26. The image forming apparatus of claim 24, wherein each of the one or more nano particles comprises a nano-sphere or a nano-rod.

27. The image forming apparatus of claim 26, wherein each of the one or more nano particles comprises at least one metal selected from the group including Ag, Au, Pt, Pd, Fe, Ni, Al, Sb, W, Tb, Dy, Gd, Eu, Nd, Pr, Sr, Mg, Cu, Zn, Co, Mn, Cr, V, Mo, Zr and Ba.

28. The image forming apparatus of claim 24, wherein the light source is configured to emit light of a single wavelength, each of the one or more nano particles having an aspect ratio with which a peak wavelength of absorption spectrum of each of the one or more nano particles corresponds to the single wavelength of the light emitted from the light source.

29. The image forming apparatus of claim 25, wherein the light source is configured to emit light having a range of wavelengths, each of the one or more nano particles having a respective corresponding one of a plurality of aspect ratios such that the one or more nano particles have a plurality of peak wavelengths of absorption spectrum, each of which being in the range of wavelengths of the light emitted from the light source.

30. The image forming apparatus of claim 25, wherein the light source is configured to emit light having a range of wavelengths, and
wherein the light-absorptive layer comprises a plurality of dielectric layers each having a different dielectric constant from one another, and
wherein ones of the one or more nano particles dispersed in any one of the plurality of dielectric layers having a peak wavelength of absorption spectrum that belongs in the range of wavelengths of the light emitted from the light source.
